(19) United States
(12) Patent Application Publication
(10) Pub. No.: US 2002/0178654 A1
(43) Pub. Date: Dec. 5, 2002

(54) Electrical plug bus door operator

(76) Inventor: Stefan Pagowski, Glen Ellyn, IL (US)

Correspondence Address: JAMES RAY & ASSOCIATES, 2640 Pitcairn Road, Monroeville, PA, 15146, US

(21) Appl. No.: 10/139,082

(22) Filed: May 3, 2002

Related U.S. Application Data
(60) Provisional application No. 60/289,218, filed on May 7, 2001.

(51) Int. Cl. E06B 11/00

(52) U.S. Cl. 49/329

(57) ABSTRACT

An electric door operator for controlling the opening and closing of a door pivotally mounted to a door frame of a multi-passenger mass transit vehicle is provided. The electric door operator comprises a gear sector having an aperture extending through a center portion thereof. The gear sector is mounted for rotation in opposite directions through opening and closing cycles of the door. A first supporting ring having a aperture extending through a center portion thereof is positioned adjacent to the gear sector such that the aperture of the first supporting ring is in alignment with the aperture of the gear sector to form an actuating assembly. A shaft member extends through the apertures of the gear sector and the first supporting ring. A push bar is suspended from the first supporting ring and is pivotally secured to a door lever. A driving means is provided for driving the actuating assembly such that the actuating assembly rotates about the shaft member and applies a force to the push bar for one of opening and closing the door. The operator is also designed such that it is capable of sequentially releasing a latching mechanism and then opens the door through the use of a single gear motor.

### CROSS-REFERENCE TO RELATED APPLICATIONS

This application claims benefit of provisional application No. 60/289,218, directed to “Electrical Plug Bus Door Operator”, filed May 7, 2001. This application is also related to U.S. Ser. No. ______, directed to “An Electric Door Operator”, filed ______, U.S. Ser. No. ______, directed to “Emergency Release Mechanism For An Electrical Door Operator”, filed ______, and U.S. Ser. No. ______, directed to “Latch Door”, filed ______. The specifications of these applications are hereby incorporated by reference thereto.

### FIELD OF THE INVENTION

This invention relates generally to power operators for multi-passenger mass transit vehicles, more particularly to an electrically driven rotary door operator for opening and closing a pivotally mounted door commonly used in multiple passenger vehicles including airport utility transports, school, and small transit buses.

### BACKGROUND OF THE INVENTION

Prior to the use of power operated door openers, doors of mass transit vehicles were manually opened and closed, typically by the vehicle operator. The strain of actuating these door openings and closings often led to long term medical difficulties for the vehicle operators. The need for power operated door openers led to the development of largely pneumatically actuated operators since in most large vehicles, use of air brake systems provides a reliable and convenient source of operating air at controlled pressures. U.S. Pat. Nos. 4,490,941 and 4,134,231 show examples of pneumatic powered door operators. However, these types of vehicles typically incorporate hydraulic brake systems. Therefore, no air supply is available, and hydraulic door drives are high in cost and involve excessive maintenance in order to prevent leaks and loss of brake system integrity. A growing need for a reliable low cost electric bus door operator now exists.

A power door operator for multi-passenger mass transit vehicles is disclosed in U.S. Pat. No. 5,332,279, the specification of which is hereby incorporated by reference. This type of prior art system incorporates an electrically driven gear motor operating drive arms rotating approximately 160° in order to open and close a dual panel swing door set. A gear motor drive shaft operating through a sleeve clutch operates individually adjustable length drive arms of a drive bar in order to effect approximately 90° rotation of each door from open to closed and closed to open. The operating door shafts located at the outer edges of each panel have door arms affixed thereto for connection to the above-mentioned reciprocating drive arms through door drive rods. Each door drive rod end is interfaced between its respective drive arm and door arm with a spherical rod end.

Various types of single bus type door closing systems are known. Examples of these known systems are described in U.S. Pat. Nos. 4,282,686; 4,924,625; 4,932,715; 5,263,280 and 5,421,395, the specifications of which are hereby incorporated by reference.

### SUMMARY OF THE INVENTION

The present invention is directed to an electric door operator for controlling the opening and closing of a door pivotally mounted to a door frame of a multi-passenger mass transit vehicle. The electric door operator comprises a gear sector having a aperture extending through a center portion thereof. The gear sector is mounted for rotation in opposite directions through opening and closing cycles of the door. A first supporting ring having a aperture extending through a center portion thereof is positioned adjacent to the gear sector such that the aperture of the first supporting ring is in alignment with the aperture of the gear sector to form an actuating assembly. A shaft member extends through the apertures of the gear sector and the first supporting ring. A push bar having a first and second end is provided. The first end of the push bar is suspended from the first supporting ring and a second end of the push bar is pivotally secured to either the door or a door lever. A driving means is provided for driving the actuating assembly such that the actuating assembly rotates about the shaft member and applies a force to the push bar for one of opening and closing the door.

### OBJECTS OF THE INVENTION

It is an object of the invention to provide to an electrically driven rotary door operator for opening and closing a pivotally mounted door commonly used in multiple passenger vehicles including airport utility transports, school, and small transit buses.

It is another object of the invention to provide a door operator which sequentially releases a latching mechanism then opens the door.

Another object of the invention is to design the operator such that the push bar and its associated linkage is supported so as to minimizes the bending action and related stresses.

It is another object of the invention to design the operator such that the gear sector carries only torsional forces.

It is still another object of the invention to provide a door operator which is economically produced and requires minimal maintenance.

It is yet another object of the invention to provide a door operator which is slimmer and lighter in weight than previously used door operators.

In addition to the objects and advantages listed above, various other objects and advantages of the latch door operator disclosed herein will become more readily apparent to persons skilled in the relevant art from a reading of the detailed description section of this document.

### BRIEF DESCRIPTION OF THE DRAWINGS

FIG. 1 shows a partial cut-away perspective view of the sector/pinion of the invention.

FIG. 2 shows a cross-sectional side view of FIG. 1.

FIG. 3 shows a partial cross-sectional view of the sector connection assembly.

FIG. 4 shows a plane view of the sector.

FIG. 5 shows a plane view of the electrical bus door operator of the invention.

FIG. 6 shows a cross-section side view of the electrical operator of FIG. 5.

FIG. 7 shows another view of the electrical bus door operator of the invention mounted above a door of a vehicle.

### DETAILED DESCRIPTION OF THE INVENTION

The following background information is provided to assist the reader to understand the environment in which the invention will typically be used. The terms used herein are not intended to be limited to any particular narrow interpretation unless specifically stated otherwise in this document.

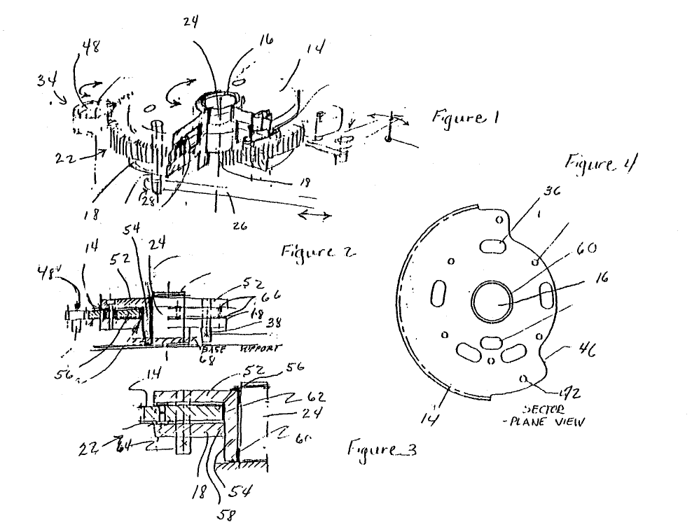

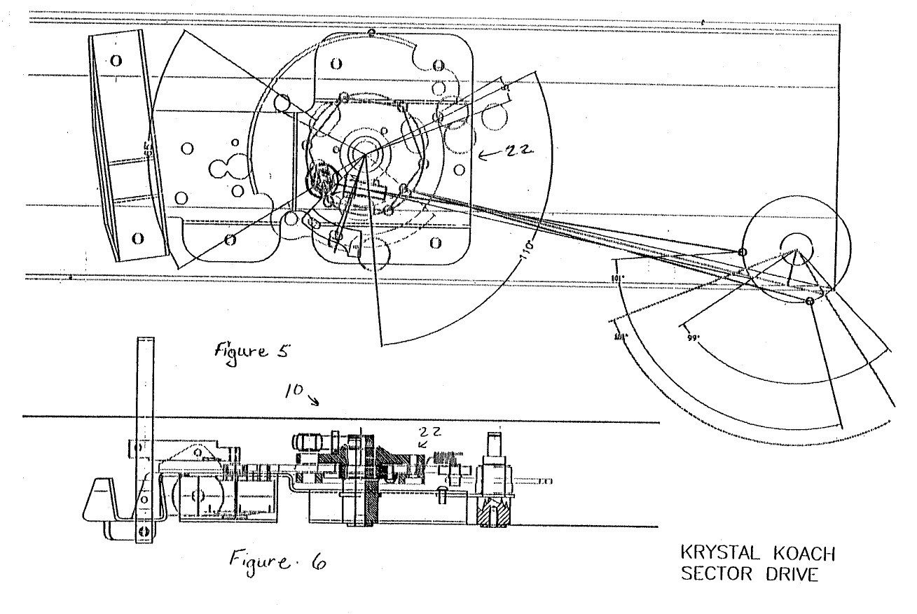

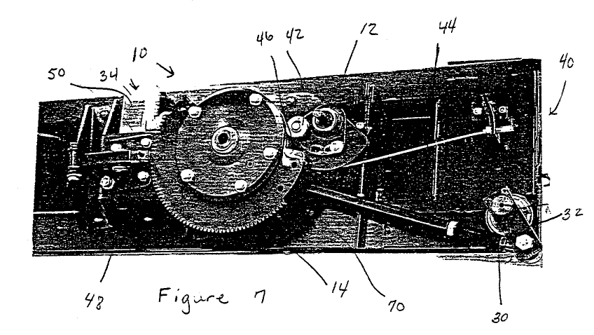

Referring now to FIGS. 1 and 5-7 which show the electric door operator, generally indicated as 10, for controlling the opening and closing of a door pivotally mounted to a door frame 12 of a multi-passenger mass transit vehicle. The electric door operator 10 comprises a gear sector 14 having an aperture 16 extending through a center portion thereof. The gear sector 14 is mounted for rotation in opposite directions through opening and closing cycles of the door. A first supporting ring 18 having a aperture extending 20 through a center portion thereof is positioned adjacent to the gear sector 12 such that the aperture 20 of the first supporting ring 18 is in alignment with the aperture 16 of the gear sector 14 to form an actuating assembly, generally indicated as 22. A shaft member or stem 24 extends through the apertures 16, 20 of the gear sector 14 and the first supporting ring 18. A push bar 26 having a first 28 and second 30 end is provided. The first end 28 of the push bar 26 is suspended from the first supporting ring 18 and the second end 30 of the push bar 26 is pivotally secured to either the door or a door lever 32. A driving means, generally indicated as 34, is provided for driving the actuating assembly 22 such that the actuating assembly 22 rotates about the shaft member 24 and applies a force to the push bar 26 for one of opening and closing the door.

The particular design of the operator wherein the linkage (e.g. push bar 26 and associated linkage) is suspended from the first supporting ring 18 so bending action from its force is carried by the supporting shaft 24. This assures that the gear sector 14 carries only torsional forces. Suspending the linkage between the supporting ring 18 and the supporting shaft 24 minimizes the bending action and related stresses.

As shown in FIGS. 2 and 4, the operator further includes a means for mounting the gear sector 14 with respect to the first supporting ring 18 such that the gear sector 14 can rotate a first predetermined distance while the first supporting ring 18 remains stationary. The means for mounting the gear sector 14 with respect to the first supporting ring 18 comprises a plurality of elongated holes 36 extending through the gear sector 14 and pin members 38 extending through the elongated holes 36 for securing the first supporting ring to the gear sector 14. These elongated holes 36 in the gear sector 14 allow for angular motion of the gear sector 14 with respect to the first supporting ring 18.

Now referring to FIG. 7, the operator further includes a locking mechanism, generally indicated as 40, a cam 42 mounted adjacent to the gear sector 14 and a cable member 44 attached between the cam 42 and the locking mechanism 40. The cam 42 is capable of rotating in response to contact with a portion 46 of the gear sector 14 upon rotation of the gear sector 14 the first predetermined distance. This rotation of the cam 42 results in the release of tension applied to the cable member 44 which releases the locking mechanism 40 of the electric door operator 10.

The driving means 34 is capable of rotating the gear sector a first predetermined distance to release the locking mechanism 40 and is capable of rotating the actuating assembly 22 a second predetermined distance to either open and/or close the door. The driving means 34 can comprise a pinion 48 which intermeshes with the gear sector 14 and a gear motor 50 for rotating this pinion 48.

As shown in FIGS. 2-3, the door operator 10 can further include a second supporting ring 52, positioned adjacent with the gear sector 14 such that the gear sector 14 is sandwiched between the first and second supporting rings 18, 52.

The elongated holes 36 in the gear sector 14 allow for angular motion of the gear sector 14 with respect to the first and second supporting rings 18, 52. The relative motion range of the gear sector 14 is limited by the span of the elongated holes 36 used for pin members 38 connecting the supporting rings 18, 52. The motion of the gear sector 14 between the supporting rings 18, 52 is needed for driving the locking mechanism 40 independent from the push bar 26 and linkage. During this motion, the gear sector 14 works as a cam. When the sector rotates with its supporting rings 18, 52, the push bar 26 and linkage suspended from the supporting ring structure 18, 52 drives a main mechanism. In the present application, it drives the door shaft and the cam drives the door latch.

The second supporting ring 52 can be cup-shaped such that a leg portion 54 of the second supporting ring 52 is perpendicular to an end portion 56 of the gear sector 14 and an end portion 58 of the first supporting ring 18. This leg portion 54 is also positioned adjacent to the shaft member 24 and at least one radial bearing 60 is positioned between the leg portion 54 and the shaft member 24 to enable rotation of the actuating assembly 22 and the second supporting ring 52 with respect to the shaft member 24.

A radial bearing 62 is also positioned between the end portion 56 of the gear sector 14 and the leg portion 54 of the second supporting ring 52 to enable rotation of the gear sector 14 with respect to the first and second supporting rings 18, 52 the first predetermined distance in order to release the locking mechanism 40.

A driving pin 64 is provided which extends upward through the gear sector 14 and into the second supporting ring 52 for joining each of the first and second supporting rings 18, 52 and the gear sector 14. This driving pin 64 can be positioned within an aperture extending through the supporting rings 18, 52 and gear sector 14. The first end 28 of the push bar 26 is secured to the driving pin 64.

At least one slider 66 is positioned between the gear sector 14 and at least one of or both of the first and second supporting rings 18, 52. The slider(s) 66 are preferably formed from a friction reducing material such as plastic or any other well known friction reducing material.

The door operator 10 is designed such that the pinion 48 is capable of being disengaged from the gear sector 14 to enable manual opening of such door. Devices for disengaging a pinion are disclosed in the aforementioned related patent application Ser. Nos. ______ and ______.

The shaft member 24 is engageable with either a base plate 68 or a wall portion 70 of such vehicle so that the door operator may be readily removed from the vehicle for maintenance and/or replacement thereof.

A stop means 72, as shown in FIG. 4, is mounted on the gear sector 14 for limiting the rotation of the gear sector 14. This stop means 72 cooperates with at least one limit switch in order to stop the rotation of the gear sector upon one of opening and/or closing of the vehicle. The limit switch(es) send signals to the gear motor 50 that the opening and/or closing operation of the door is complete and that the direction of the motor should be changed so that the pinion 48 rotates in an opposite direction.

In the case of dual swing door arrangements a connecting means (not shown) can be secured to a second door for one of opening and closing the second door upon actuation of the driving means 34. This connecting means can comprise any well known means such as a rod, cable, and the like.

The inventive concept of the present invention is the driving of two independent mechanisms from one source, a gear motor 50, with the possibility to activate one only, latch, during emergency release, when the door pushing from the inside of a bus, drives the gear sector 14 and pinion 48 is disengaged from the gear motor 50. The invention also provides sequential actuation and simultaneous action of the door and mechanical latching device 40.

The invention has been described in such full, clear, concise and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

I claim:

1. An electric door operator for controlling the opening and closing of a door pivotally mounted to a door frame of a multi-passenger mass transit vehicle, said electric door operator comprising:
(a) a gear sector having a aperture extending through a center portion thereof, said gear sector being mounted for rotation in opposite directions through opening and closing cycles of such door;
(b) a first supporting ring having a aperture extending through a center portion thereof, said first supporting ring being positioned adjacent to said gear sector such that said aperture of said first supporting ring is in alignment with said aperture of said gear sector to form an actuating assembly;
(c) a shaft member extending through said aperture of said gear sector and said aperture of said first supporting ring;
(d) a push bar having a first and second end, said first end of said push bar being suspended from said first supporting ring and a second end of said push bar being pivotally secured to one of a door and a door lever; and
(e) driving means for driving said actuating assembly such that said actuating assembly rotates about said shaft member and applies a force to said push bar for one of opening and closing such door.

2. An electric door operator as recited in claim 1 further including a means for mounting said gear sector with respect to said first supporting ring such that said gear sector can rotate a first predetermined distance while said first supporting ring remains stationary.

3. An electric door operator as recited in claim 2 wherein said means for mounting said gear sector with respect to said first supporting ring comprises a plurality of elongated holes extending through said gear sector and pin members extending through said elongated holes for securing said first supporting ring to said gear sector.

4. An electric door operator as recited in claim 2 wherein the operator further includes a locking mechanism, a cam mounted adjacent to said gear sector and a cable member attached between said cam and said locking mechanism, said cam capable of rotating in response to contact with a portion of said gear sector upon rotation of said gear sector said first predetermined distance, said rotation of said cam resulting in the release of tension applied to said cable member which releases said locking mechanism of said electric door operator.

5. An electric door operator as recited in claim 4 wherein said driving means is capable of rotating said gear sector a first predetermined distance to release said locking mechanism and is capable of rotating said actuating assembly a second predetermined distance to one of open and close such door.

6. An electric door operator as recited in claim 1 wherein said driving means comprises a pinion which intermeshes with said gear sector and a gear motor for rotating said pinion.

7. An electric door operator as recited in claim 1 further including a second supporting ring, positioned adjacent with said gear sector such that said gear sector is sandwiched between said first and second supporting rings.

8. An electric door operator as recited in claim 7 wherein said second supporting ring is cup-shaped and wherein a leg portion of said second supporting ring is perpendicular to an end portion of said gear sector and an end portion of said first supporting ring.

9. An electric door operator as recited in claim 8 wherein said leg portion is positioned adjacent to said shaft member and at least one bearing is positioned between said leg portion and said shaft member.

10. An electric door operator as recited in claim 9 including a bearing positioned between said end portion of said gear sector and said leg portion of said second supporting ring.

11. An electric door operator as recited in claim 7 further including a driving pin for joining each of said first and second supporting rings and said gear sector.

12. An electric door operator as recited in claim 11 wherein said first end of said push bar is secured to said driving pin.

13. An electric door operator as recited in claim 12 including at least one slider positioned between said gear sector and at least one of or both of said first and second supporting rings.

14. An electric door operator as recited in claim 13 wherein said at least one slider is formed from a friction reducing material

15. An electric door operator as recited in claim 6 wherein said pinion is capable of being disengaged from said gear sector to enable manual opening of such door.

16. An electric door operator as recited in claim 1 wherein said shaft member is engageable with one of a base plate and a wall portion of such vehicle.

17. An electric door operator as recited in claim 1 including a stop means mounted on said gear sector for limiting the rotation of said gear sector.

18. An electric door operator as recited in claim 1 further including a connecting means secured to a second door for one of opening and closing such second door upon actuation of the driving means.
